(19) United States
(12) Patent Application Publication
(10) Pub. No.: US 2009/0126873 A1
(43) Pub. Date: May 21, 2009

(54) METHOD FOR PROTECTING PRINTED IMAGE AND APPARATUS THEREFOR

(75) Inventors: Kunihiko MATSUHASHI, Nagano-Ken (JP); Hajime MIZUTANI, Nagono-Ken (JP); Hiroyuki ONISHI, Nagano-Ken (JP); Nobuaki NAKAOKA, Wakayama-Ken (JP); Hironori MASUTANI, Wakayama-Ken (JP)

Correspondence Address: LADAS & PARRY LLP, 26 WEST 61ST STREET, NEW YORK, NY, 10023, US

(73) Assignees: SEIKO EPSON CORPORATION; NORITSU KOKI CO., LTD.

(21) Appl. No.: 12/337,660

(22) Filed: Dec. 18, 2008

Related U.S. Application Data
(62) Division of application No. 11/041,006, filed on Jan. 21, 2005.

(30) Foreign Application Priority Data
Jan. 21, 2004 (JP) 2004- 13538
Nov. 17, 2004 (JP) 2004-332596
Nov. 17, 2004 (JP) 2004-332684

(51) Int. Cl. B65C 9/32

(52) U.S. Cl. 156/387

(57) ABSTRACT

Disclosed is a method for overcoating a protective layer by heating onto a printed recording medium to protect the recording medium. This method comprises providing a transferable sheet comprising a heat resistant substrate and a transferable layer, which serves as the protective layer, and a recording medium, putting the transferable sheet on the recording medium and, in this state, heating and pressing the transferable sheet and/or the recording medium to contact-bond the transferable layer onto the recording medium, and then heating and pressing the transferred layer contact-bonded to the recording medium. According to this method, a good protective layer can be overcoated onto the recording medium independently of the shape of concaves and convexes formed on the surface of the recording medium.

### RELATED APPLICATIONS

This application claims the benefit of priority based on Japanese Patent Application Nos. 13538/2004 (filing date: Jan. 21, 2004), 332596/2004 (filing date: Nov. 17, 2004), and 332684/2004 (filing date: Nov. 17, 2004), the entireties of which are incorporated herein by reference.

### FIELD OF THE INVENTION

The present invention relates to a method for overcoating a protective layer by heating onto a printed recording medium and an apparatus therefor.

### BACKGROUND ART

An ink jet recording method is a recording method in which ink droplets are ejected through fine nozzles in response to image signals sent from a computer or the like and are deposited onto a recording medium to perform printing.

In recent years, with the expansion of an ink jet recording technique to digitized photographic services, commercial printing applications and the like, importance has become attached to storage stability of images formed by ink jet recording, for example, waterfastness, gasfastness, and heat resistance, and an improvement of the images in storage stability is an important issue.

To overcome the problems, for example, a method for protecting an image has been known wherein a transparent film or the like is laminated as a protective layer on the surface of an image formed by deposition of ink to improve storage stability and gloss of the image.

Among methods for lamination of the image surface are included a cold lamination method in which a transparent film having adhesion at room temperature is provided and is applied onto the image surface while peeling off backing paper (separator) for protecting the adhesion. The lamination methods also include a heat (hot) lamination method in which a transparent film of a thermoplastic resin free from backing paper is provided and is applied onto an image surface while heating the transparent film, and a transfer-by-heating method in which a substrate and a transparent film to be transferred as a protective layer are provided and the transparent film is transferred by heating onto an image surface. In particular, in the case of the transfer-by-heating method, as compared with other lamination methods, the thickness of the protective layer can be reduced, and, hence, advantageously, excessive glossy feeling is not imparted to the image surface. This method has drawn attention as a lamination method which can improve storage stability and gloss of images without sacrificing handle or texture inherent in the record (for example, Japanese Patent Laid-Open No. 121777/2001).

The transfer-by-heating method, however, is disadvantageous in that, upon inclusion of a deposit such as dirt, dust or the like deposited on the image surface into between the image surface and the transferred layer, air bubbles are formed around the deposit resulting in the formation of a nonbonding space larger than the deposit which poses a problem of a deterioration in storage stability and gloss of the image. In this case, when the inclusion of air bubbles has been observed, after the transferred layer is peeled off, a new transferable layer is again transferred by heating. This can improve the storage stability and gloss. In this method, however, the cost of the transfer-by-heating method is high, for example, due to the time necessary for peeling off the transferred layer, the use of a transferable layer to be newly transferred by heating and the like.

Further, in the case of uneven paper of which the image surface has been treated for rendering the image surface uneven (for example, matte paper and luster paper), the image surface is bonded to the transferred layer by only the convex part. Therefore, air bubbles are included in the surface concave part, and, in some cases, the adhesion between the image surface and the transferable layer cannot be maintained.

### SUMMARY OF THE INVENTION

An object of the present invention is to provide a method which can overcoat a protective layer onto a recording medium without forming a noncontact-bonding space due to air bubbles or the like even when the surface of the recording medium has concaves and convexes, and to provide an apparatus therefor.

The above object can be attained by a method for overcoating a protective layer by heating onto a recording medium, the method comprising: providing a transferable sheet comprising at least a heat resistant substrate and a transferable layer, which serves as the protective layer, and a recording medium; putting the transferable sheet on the recording medium and, in this state, heating and pressing the transferable sheet and/or the recording medium to contact-bond the transferable layer onto the recording medium to perform a first hot pressing step; and heating and pressing the transferred layer contact-bonded to the recording medium to perform a second hot pressing step.

According to another aspect of the present invention, there is provided an apparatus for overcoating a protective layer by heating onto a recording medium, the apparatus comprising at least: means for feeding a transferable sheet comprising at least a heat resistant substrate and a transferable layer; means for feeding a recording medium; first hot pressing means for putting the transferable sheet on the recording medium and, in this state, heating and pressing the transferable sheet and/or the recording medium to contact-bond the transferable layer onto the recording medium; and second hot pressing means for heating and pressing the transferred layer contact-bonded to the recording medium.

### BRIEF DESCRIPTION OF THE DRAWINGS

FIG. 1 is a diagram illustrating the apparatus in a first embodiment of the present invention;

FIG. 2 is an enlarged cross-sectional view of a recording medium;

FIG. 3 is an enlarged cross-sectional view of a transferable sheet;

FIG. 4 is an enlarged cross-sectional view of a recording medium before undergoing a first hot pressing step;

FIG. 5 is an enlarged cross-sectional view of a contact-bonded product after undergoing a first hot pressing step;

FIG. 6 is an enlarged cross-sectional view of a contact-bonded product after undergoing a separating step;

FIG. 7 is an enlarged cross-sectional view of a contact-bonded product after undergoing a second hot pressing step;

FIG. 8 is a diagram illustrating an apparatus in a second embodiment of the present invention;

FIG. 9 is a block diagram illustrating a control unit for controlling avoidance means; and

FIG. 10 is a diagram illustrating an ink jet recording apparatus in a third embodiment.

### DETAILED DESCRIPTION OF THE INVENTION

In the method according to the present invention, a transferable sheet is contact bonded to a recording medium as the first hot pressing step, and the contact-bonded layer transferred from the transferable sheet is again heated and pressed as the second hot pressing step. Therefore, a nonbonding space which is sometimes formed between the transferred layer and the recording medium in the first hot pressing step can be again hot pressed by the second hot pressing step and is eliminated.

This method further comprises, after any one of the first hot pressing step and the second hot pressing step, the step of separating the heat resistant substrate from the transferred sheet contact-bonded to the recording medium.

According to this method, in the separating step, the heat resistant substrate is separated from the recording medium with the transferable layer transferred thereon. Therefore, only the transferable layer is transferred onto the recording medium.

In this method, the temperature and pressure supplied to the transferable layer in the second hot pressing step are below the temperature and pressure in the first hot pressing step.

According to this method, the transferred layer can be again hot pressed in such a state that the adhesion between the transferable sheet and the recording medium which have been contact bonded to each other by the first hot pressing means is maintained.

In this method, for the recording medium having a printing surface with a roughness of not less than 0.15 as measured according to JIS B 0601, the first hot pressing step and the second hot pressing step are carried out, while, for the recording medium having a printing surface with a roughness of less than 0.15, only the first hot pressing step is carried out.

According to this method, when the surface roughness of the printing surface is not less than 0.15 as measured according to JIS B 0601, that is, when the printing surface of the recording medium is slightly rough, the transferred layer contact bonded to the recording medium is subjected to the second hot pressing step in which the transferred layer is again heated and pressed. This allows the noncontact-bonding space (air bubble), which is sometimes formed between the printing surface and the transferred layer, to disappear. Therefore, a print free from the noncontact-bonding space can be provided. In the case of the recording medium having a smooth printing surface which is less likely to form a noncontact-bonding space, the second hot pressing step is not carried out and, thus, a deterioration in texture and the like by transfer by heating can be prevented.

In this method, the recording medium is printed with a pigment ink.

According to this method, the transferable layer is transferred onto a recording medium having a printing surface printed with a pigment ink. Therefore, unevenness of gloss in the printing surface between the pigment ink deposited printed site and the nonprinted site can be prevented, and a high-quality print can be prepared.

In this method, the recording medium comprises resin coated paper comprising a substrate coated with a resin layer, and a receptive layer receptive to a pigment ink is provided on the printing surface.

According to this method, the recording medium is resin coated paper, and a receptive layer receptive to a pigment ink is formed on the printing surface. Therefore, a high-quality print can be provided.

In the apparatus according to the present invention, a nonbonding space which is sometimes formed between the transferable layer and the recording medium by the first hot pressing means can be removed by the second hot pressing means.

This apparatus comprises separating means for separating the heat resistant substrate from the transferable sheet contact bonded to the recording medium.

According to this apparatus, the heat resistant substrate is separated by separating means from the recording medium with the transferable layer transferred thereon. Therefore, only the transferable layer is transferred onto the recording medium.

In this apparatus, the temperature and pressure of the second hot pressing means each are below the temperature and pressure of the first hot pressing means.

According to this apparatus, the transferred layer can be again heated and pressed in such a state that the adhesion between the transferable sheet and the recording medium contact bonded to each other by the first hot pressing means is maintained.

In this apparatus, at least one of the first hot pressing means and the second hot pressing means comprises regulating means for regulating the temperature and the pressure.

According to this apparatus, the temperature and pressure of the hot pressing means can be regulated. To this end, the temperature and heat/pressure for the hot pressing means depending upon the shape of surface concaves and convexes of the recording medium and the thickness of the transferable layer and the heat resistant substrate constituting the transferable sheet can be supplied.

This apparatus comprises avoidance means for avoiding the transferred layer in the transferable sheet contact-bonded to the recording medium from the second hot pressing means. When the surface roughness of a printing surface of the recording medium is less than 0.15 as measured according to JIS B 0601, the avoidance means allows the transferred layer in the transferable sheet to avoid the second hot pressing means.

According to this apparatus, the second hot pressing means can be avoided by the avoidance means. When the recording medium has a printing surface with a roughness of less than 0.15 as measured according to JIS B 0601, that is, when a noncontact space is not formed between the transferred layer and the recording medium by the first hot pressing means, the second hot pressing means can be avoided. Thus, transfer can be carried out under suitable conditions depending upon the shape of surface concaves and convexes of the recording medium and the thickness of the transferable layer and the heat resistant substrate constituting the transfer sheet and the like.

### Transferable Sheet and Recording Medium

The present invention provides a method for overcoating and stacking a protective layer onto a recording medium by heating, and an apparatus therefor. The transferable sheet used in the present invention comprises a heat resistant substrate and a transferable layer.

Preferably, the heat resistant substrate has heat resistance on a level that can stably maintain its shape under predetermined hot contact bonding conditions during transfer by heating and can easily be separated from the transferred layer contact bonded to the printing surface (receptive layer) of the recording medium. Specific examples thereof include resin films of polyethylene terephthalate (PET), biaxially stretched polypropylene (OPP), polyethylene naphthalate (PEN), polyphenyl sulfide (PPS), polyether sulfone (PES), polystyrene (PS), polypropylene (PP) and the like. The thickness of the substrate is not particularly limited so far as the above function can be obtained. Preferably, however, the thickness is 8 to 60 μm, more preferably 10 to 50 μm, from the viewpoints of heat conductivity, adhesion, handleability, prevention of the inclusion of air bubbles at the time of transfer by heating and the like.

The transferable layer is transferred onto the printing surface of the recording medium to protect the image. Materials for the transferable layer include, for example, acrylic resin, acryl-styrene resin, acryl-urethane resin, polyvinyl acetal, vinyl acetate resin, vinyl chloride-vinyl acetate resin, and styrene resin. One of or a mixture of two or more of them may be used for transferable layer formation.

The transferable layer may have a single-layer structure. However, the adoption of a multilayer structure formed by stacking additional one or at least two layers is preferred from the viewpoint of good balance among properties such as transferability, adhesion, weathering resistance, antiblocking properties, and abrasion resistance. In particular, preferably, an adhesive layer S3 is stacked on the protective layer (transferable layer S2) to form a transferable layer having a two-layer structure. When the adhesive layer and the protective layer are stacked, the glass transition temperature of the protective layer is preferably above the glass transition temperature of the adhesive layer. The difference in glass transition temperature between the layers is preferably about 10 to 100° C. In a preferred embodiment of the present invention, the glass transition temperature of the adhesive layer is preferably −20 to 60° C., more preferably −15 to 55° C., for example, from the viewpoint of adhesion to the printing surface (receptive layer) of the recording medium. The glass transition temperature of the protective layer is preferably 30 to 130° C., more preferably 35 to 125° C., from the viewpoint of improving antiblocking properties and abration resistance.

If necessary, the transferable layer contains various additives, for example, inorganic pigments such as silica, waxes, film-forming assistants, ultraviolet absorbers, photostabilizers, antioxidants, waterproofing agents, preservatives, surfactants, thickeners, fluidity improvers, pH adjusters, leveling agents, and antistatic agents.

The protective layer and the adhesive layer may be formed by mixing a layer forming material optionally with a suitable solvent to prepare a coating liquid, coating the coating liquid onto the heat resistant substrate, and drying the coating. Coating may be carried out by various coating methods such as roll coating, rod bar coating, or air knife coating.

Further, the thickness of the transferable layer (protective layer and adhesive layer) is preferably 2 to 50 μm, more preferably 5 to 30 μm. When the thickness of the transferable layer is in this range, good printing surface protecting effect, an improvement in glossy impression, and transparency can be realized. When the protective layer and the adhesive layer are stacked on top of each other, the thickness of the protective layer is preferably 1 to 28 μm while the thickness of the adhesive layer is preferably 2 to 29 μm.

Paper, coated paper, ink jet recording paper, nonwoven fabrics, various resin films and the like can be used as the recording medium in the present invention. In particular, when high-quality prints are required, ink jet recording paper is preferred. Further, ink jet recording paper comprising a receptive layer formed on at least one side (printing surface) of resin coated paper is preferred. The resin coated paper comprises a resin layer such as polyethylene provided on both sides of a substrate (base paper) and has excellent waterfastness. The receptive layer may be the so-called “swelling-type” receptive layer comprising a water soluble resin such as polyvinyl alcohol or polyvinylpyrrolidone as an indispensable component, or the so-called “porous material-type” receptive layer comprising a pigment such as silica or alumina and a binder as indispensable components. In particular, the latter receptive layer, i.e., the porous material-type receptive layer, is preferred.

Any recording medium may be used so far as, after printing, the transferable sheet can be adhered onto a printing surface in the recording medium as described below. Printing may be carried out, for example, by ink jet recording, offset printing, gravure printing, transfer by sublimation, transfer by fusion, or electrostatic toner recording. In particular, a print formed by ejecting and printing a pigment ink onto a recording medium by ink jet recording (a pigment ink jet print) is best suited as a print in the present invention, because the effect of improving image quality and storage stability attained by the transfer of the transferable sheet by heating is high and uneven gloss can be eliminated.

### FIRST EMBODIMENT

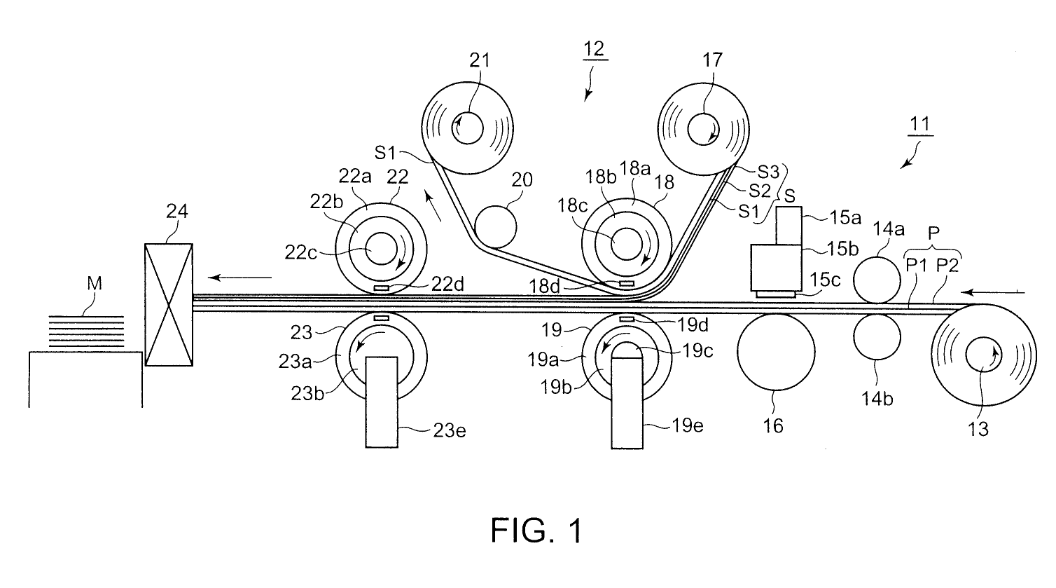

The method and apparatus in the first embodiment of the present invention will be described with reference to FIGS. 1 to 7.

In FIG. 1, the apparatus according to the present invention includes an ink jet recording part 11 as recording means and a transfer-by-heating part 12 as a transfer-by-heating apparatus.

The ink jet recording part 11 includes a sheet feeding roller 13 as recording medium feeding means, guide rollers 14a, 14b, an ink cartridge 15a, a carriage 15b, a recording head 15c, and a platen 16.

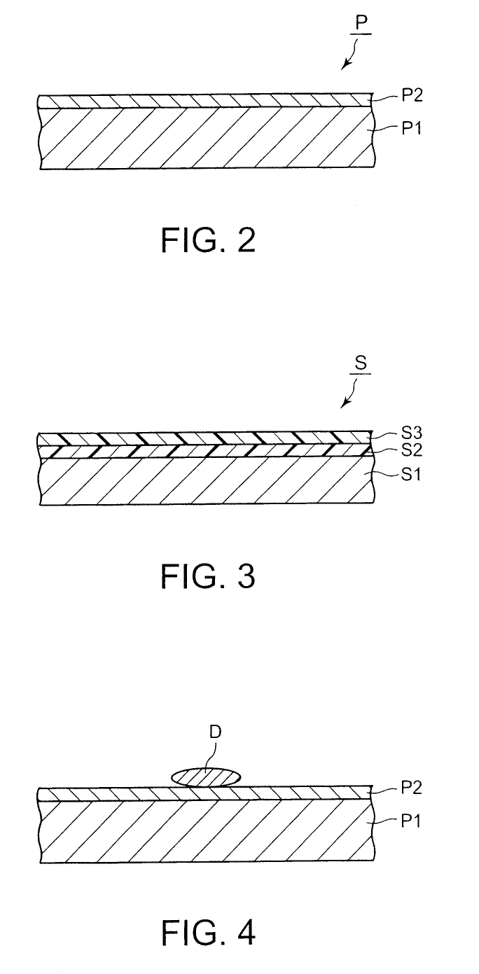

The sheet feeding roller 13 is cylindrical and is rotatable in a direction indicated by an arrow in FIG. 1. A recording medium P wound in a roll form is mounted on the circumference of the sheet feeding roller 13. As shown in FIG. 2, the recording medium P comprises a substrate P1 and a receptive layer P2 (a printing surface) formed of, for example, a mixture of an inorganic pigment (noncrystalline silica) with an organic component (a binder resin or the like). The receptive layer P2 is coated onto the substrate P1. Ink droplets are received in the receptive layer through the action of capillary force in fine gaps possessed by the inorganic pigment to form an image on the recording medium P. The recording medium P is delivered from the sheet feeding roller 13 in such a state that the receptive layer P2 faces upward. The recording medium P is carried from the right side toward the left side in FIG. 1.

Guide rollers 14a, 14b are provided on the left side (downstream side) of the sheet feeding roller 13 and respectively on the upper and lower sides of the recording medium P. The guide rollers 14a, 14b function to support the recording medium P. being carried from the sheet feeding roller 13, respectively from the upper and lower sides and to carry the recording medium P toward the downstream side.

An ink cartridge 15a, a carriage 15b, a guide member (not shown) and the like are provided on the downstream side of the guide rollers 14a, 14b and above the recording medium P. A platen 16 is provided on the underside of the recording medium P. The ink cartridge 15a reservoirs therein ink and is mounted on the carriage 15b. The carriage 15b is mounted so as to be reciprocatable along a guide member disposed in a direction perpendicular to the carrying direction of the recording medium P (scanning direction). A recording head 15c is provided on the underside of the carriage 15b. The recording head 15c is provided with nozzle openings (not shown) that receive ink from the ink cartridge 15a and ejects the ink droplets therethrough. Methods for ejecting ink droplets include a method in which ink droplets are ejected using an electromechanical transducer such as a piezoelectric element, and a method in which an ink is heated and ejected by an electrothermal transducer such as a heater element with a heating resistor. Any of them may be used in this embodiment.

The recording medium P which is carried from the right side toward the left side in such a state that the receptive layer P2 faces upward is supported from the substrate P1 side by a platen 16 which is disposed on the underside of the recording medium P. The ink is ejected onto receptive layer P2 through the recording head 15c disposed on the upside of the recording medium P. An image is formed on the recording medium P by reciprocating the carriage 15b in a scanning direction. The recording medium P with an image formed thereon is carried toward the downstream side in FIG. 1 in such a state that the receptive layer P2 faces upward.

A transfer-by-heating part 12 for transferring the transferable sheet S by heating is provided on the downstream side of the ink jet recording part 11. The transfer-by-heating part 12 includes a sheet feeding roller 17 as transferable sheet feeding means, first hot pressing rollers 18, 19 as first hot pressing means for carrying out a first hot pressing step, a guide roller 20 and a winding roller 21 as separating means for carrying out a separating step, and second hot pressing rollers 22, 23 as second hot pressing means for carrying out a second hot pressing step.

The sheet feeding roller 17 is cylindrical and is rotatable in a direction indicated by an arrow in FIG. 1. A transferable sheet S wound in a roll form is mounted on the circumference of the sheet feeding roller 17. As shown in FIG. 3, the transferable sheet S has a three-layer structure of a heat resistant substrate S1, a transferable layer S2, and an adhesive layer S3 (for example, a thermoplastic resin layer). The heat resistant substrate S1 is formed of a synthetic resin such as a polyethylene terephthalate resin. The transferable layer S2 formed of a thermoplastic resin is stacked on the heat resistant substrate S1. The adhesive layer S3 formed of a thermoplastic resin such as a polyethylene resin is stacked on the transferable layer S2. The adhesive layer S3 has a surface to be pressure-bonded to the recording medium P. The adhesive layer S3 is inactive in terms of bonding at room temperature and, upon heating, is melted and becomes adhesive to the recording medium P. The transferable layer S2, when the adhesive layer S3 is bonded to the recording medium P, functions as protective layer for protecting the image on the recording medium P. In this embodiment, the thickness of the heat resistant substrate S1 is 25 μm, the thickness of the transferable layer S2 is 4 μm, and the thickness of the adhesive layer S3 is 5 μm.

First hot pressing rollers 18, 19 as first hot pressing means are provided on the downstream side of the sheet feeding roller 17 and respectively on the underside of the substrate P1 and the upside of the heat resistant substrate S1. The first hot pressing rollers 18, 19 include elastic parts 18a, 19a, metallic rollers 18b, 19b, heaters 18c, 19c constituting regulating means, and temperature measuring parts 18d, 19d constituting regulating means. A heater may be provided in only any one of the rollers 18, 19.

The elastic parts 18a, 19a are disposed on the outermost circumference of the first hot pressing rollers 18, 19 and are formed of an elastic body, for example, a synthetic resin such as silicone rubber. The elastic parts 18a, 19a cover the whole circumference of the metallic rollers 18b, 19b underlying the elastic parts 18a, 19a. The metallic rollers 18b, 19b are a cylindrical roller formed of a metal such as iron steel and are rotated in a direction indicated by an arrow in FIG. 1. The elastic parts 18a, 19a can be rotated in conjunction with the rotation of the metallic rollers 18b, 19b. Heaters 18c, 19c are provided respectively on inner sides of the metallic rollers 18b, 19b. The heaters 18c, 19c heat the elastic parts 18a, 19a through the metallic rollers 18b, 19b and feed the quantity of heat which brings the temperature of the elastic parts 18a, 19a to the preset temperature of the first hot pressing step. Preferably, the temperatures of the elastic parts 18a, 19a are measured respectively with temperature measuring parts 18d, 19d provided on the side periphery of the elastic parts 18a, 19a. The heating temperature may be properly determined so far as the heating temperature is satisfactory for transfer of the transferable layer and does not adversely affect the printed image. Preferably, however, the heating temperature is 9 to 110° C., more preferably 100° C.

A lifting/lowering part 19e is provided in the first hot pressing roller 19 provided on the underside of the recording medium P. The lifting/lowering part 19e can lift and lower the first hot pressing roller 19 toward the stationary first hot pressing roller 18. The lifting/lowering part 19e regulates the space between the first hot pressing rollers 18, 19 for setting pressure for pressure-contacting of the recording medium P with the transferable sheet S by the first hot pressing rollers 18, 19. The pressure between the first hot pressing rollers 18, 19 is measured with a pressure gage (not shown) provided in the lifting/lowering part 19e. This pressure may also be properly determined. Preferably, however, the pressure is 8 to 12 kg/cm², more preferably 10 kg/cm². As shown in FIG. 1, the assembly of the transferable sheet S and the recording medium P is carried toward the downstream side while pressure contacting by the first hot pressing rollers 18, 19 in such a state that the adhesive layer S3 faces the receptive layer P2.

The transferable sheet S and the recording medium P are carried while undergoing hot pressing by the first hot pressing rollers 18, 19. As a result, the adhesive layer S3 melted by the heated elastic parts 18a, 19a is brought to contact bonding to the receptive layer P2.

A guide roller 20 and a winding roller 21 constituting separating means for carrying out a separating step are provided on the downstream side of the first hot pressing rollers 18, 19. For the transferable sheet S and the recording medium P, in such a state that the adhesive layer S3 in the transferable sheet S and the receptive layer P2 in the recording medium P have been contact-bonded, the guide roller 20 separates the transferable sheet S from the recording medium P and guides and carries the transferable sheet S to a winding roller 21 located above the guide roller 20. Therefore, since the adhesive layer S3 has been contact bonded to the receptive layer P2, only the heat resistant substrate S1 is separated and is wound on the winding roller 21 through the guide roller 20. As a result, the transferred layer S2 is bonded (transferred) onto the receptive layer P2 in the recording medium P through the adhesive layer S3 and is carried together with the recording medium P.

Second hot pressing rollers 22, 23 as second hot pressing means are provided on the downstream side of the guide roller 20 and the winding roller 21 and respectively on the upside and underside of the recording medium P with the transferable layer S2 transferred thereon. As shown in FIG. 1, the second hot pressing rollers 22, 23 include elastic parts 22a, 23a, metallic rollers 22b, 23b, a heater 22c constituting regulating means, and a temperature measuring part 22d constituting regulating means.

The elastic parts 22a, 23a are disposed on the outermost circumference of the second hot pressing rollers 22, 23 and are formed of an elastic body, for example, a synthetic resin such as silicone rubber. The elastic parts 22a, 23a cover the whole circumference of the metallic rollers 22b, 23b underlying the elastic parts 22a, 23a. The metallic rollers 22b, 23b are a cylindrical metallic roller formed of a metal such as iron steel and are rotated in a direction indicated by an arrow in FIG. 1. The elastic parts 22a, 23a can be rotated in conjunction with the rotation of the metallic rollers 22b, 23b. A heater 22c is provided on the inner side of the metallic roller 22b. The heater 22c heats the elastic part 22a through the metallic roller 22b and feed the quantity of heat which brings the temperature of the elastic part 22a to the preset temperature of the second hot pressing step. A heater may be provided on the roller 23 so that the heater, together with the roller 22, constitutes hot pressing means. Alternatively, a construction may be adopted in which the heater 22c is not provided in the roller 22 and a heater is provided in only the roller 23. The temperature of the elastic part 22a is measured in a temperature measuring part 22d provided on the side edge of the elastic part 22a. As with the first hot pressing means, the temperature may be properly determined. Preferably, however, the temperature is below the temperature of the elastic parts 18a, 19a which is the temperature of the first hot pressing rollers 18, 19, specifically preferably 60 to 100° C., more preferably 80° C.

A lifting/lowering part 23e is provided in the second hot pressing roller 23 provided on the underside of the recording medium P. The lifting/lowering part 23e can lift and lower the second hot pressing roller 23 toward the stationary second hot pressing roller 22. The lifting/lowering part 23e regulates the space between the second hot pressing rollers 22, 23 for setting pressure for pressure-contacting of the recording medium P with the transferable layer S2 transferred thereon by the second hot pressing rollers 22, 23 (second hot pressing step). The pressure between the second hot pressing rollers 22, 23 is measured with a pressure gage (not shown) provided in the lifting/lowering part 23e. As with the first hot pressing means, this pressure may also be properly determined. Preferably, however, the pressure is lower than that of the first hot pressing means, specifically preferably 3 to 7 kg/cm², more preferably 5 kg/cm². As shown in FIG. 1, the recording medium P with the transferable layer S2 transferred thereon is carried while undergoing hot pressing by the second hot pressing rollers 22, 23.

A cutter 24 is provided on the downstream side of the second hot pressing rollers 22, 23. The cutter 24 is disposed so that the inlet (not shown) of the cutter 24 is on an extension of the carrying passage of the recording medium P with the transferable layer S2 transferred thereon. The cutter 24 can cut the carried recording medium P into a predetermined length. Accordingly, the recording medium P with the transferable layer S2 transferred thereon is carried to and is passed through the cutter 24 and consequently is cut into ink jet records M as prints shown in FIG. 1.

The apparatus in this embodiment has the following advantages.

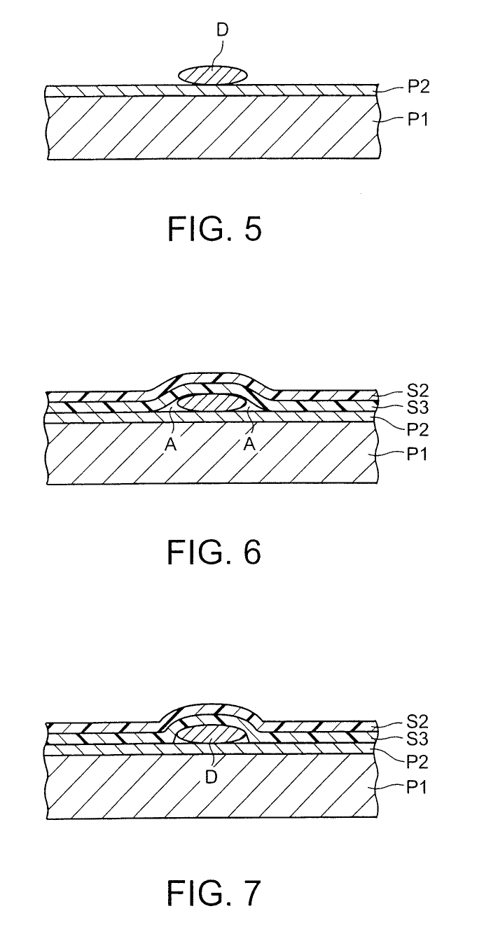

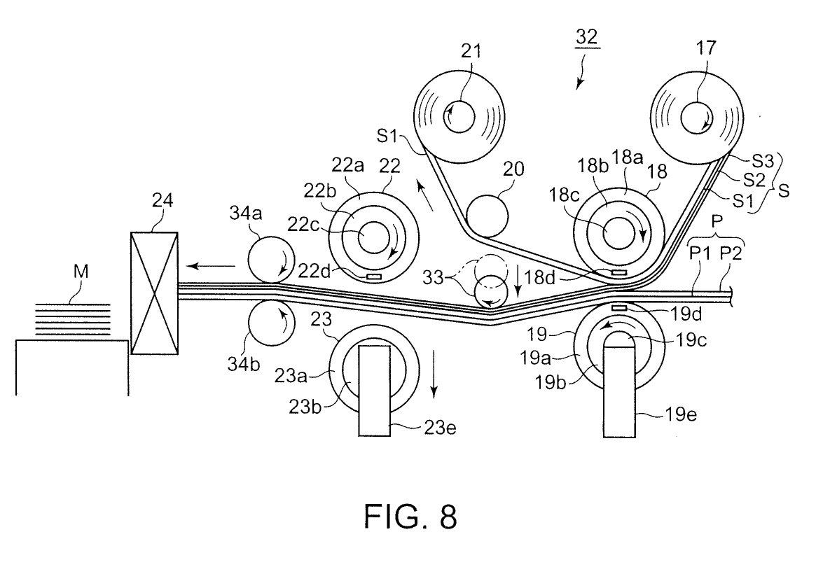

In the course of carrying of the recording medium P, for example, when dirt or dust is present in an atmosphere through which the recording medium P is carried, as shown in FIG. 4, for example, dirt or dust is sometimes adhered as a deposit D onto the receptive layer P2 in the recording medium P. The recording medium P is contact bonded to the transferable sheet S by the first hot pressing rollers 18, 19. In this case, the deposit D adhered onto the recording medium P is likewise covered with the adhesive layer S3. Therefore, in the first hot pressing rollers 18, 19, as shown in FIG. 5, air bubbles are included in the outer edge of the deposit D between the adhesive layer S3 and the receptive layer P2. In this case, the transferable sheet S is contact bonded to the recording medium P. As a result, a recording medium P having a nonbonded space A which inhibits contact between the adhesive layer S3 and the receptive layer P2 and is larger than the deposit D is formed to complete the first hot pressing step. The recording medium P with the transferable layer S2 transferred thereon is carried to the second hot pressing rollers 22, 23. In this case, the recording medium P with the transferable layer S2 transferred thereon is again heated and pressed by the second hot pressing roller 22, whereby the adhesive layer S3 covering the deposit D is again melted. Therefore, the air bubbles present on the outer periphery of the deposit D are removed through the adhesive layer S3 and the transferred layer S2 and the like. That is, the second hot pressing rollers 22, 23 reduce the nonbonded space A in the recording medium P with the transferable layer S2 transferred thereon. As a result, the adhesive layer S3 is bonded along the shape of surface concaves and convexes defined by the receptive layer P2 and the deposit D, and, as a result, as shown in FIG. 7, a recording medium P with an adhesive layer S3 and a transferred layer S2 having a shape conforming to the shape of surface concaves and convexes is formed to complete the second hot pressing step.

The recording medium P with the transferable layer S2 transferred thereon is carried to the cutter 24 and is cut into a predetermined length. Thus, the formation of ink jet records M shown in FIG. 1 is completed, and the transfer by heating is completed.

In the apparatus in this embodiment, the following effect can be attained.

In the apparatus in this embodiment, the heat resistant substrate S1 is separated from the recording medium P with the transferable sheet S contact bonded thereto by the guide roller 20 and the winding roller 21. Therefore, the transfer by heating can be completed without the need to separate the heat resistant substrate S1 by hand or the like.

Further, in this embodiment, the guide roller 20 and the winding roller 21 are provided between the first hot pressing rollers 18, 19 and the second hot pressing rollers 22, 23. Therefore, the transferable layer S2 can be again heated and pressed without through the heat resistant substrate S1. As a result, homogeneity of heating of the transferable layer S2 by the second hot pressing rollers 22, 23 can be improved.

Furthermore, in this embodiment, the temperature and pressure of the second hot pressing rollers 22, 23 are below the temperature and pressure of the first hot pressing rollers 18, 19. Therefore, the recording medium P with the transferable layer S2 transferred thereon can be again heated and pressed by the second hot pressing rollers 22, 23 without causing misregistration of the face of bonding between the adhesive layer S3, transferred by the first hot pressing rollers 18, 19, and the receptive layer P2.

Furthermore, in this embodiment, the temperature of the first hot pressing rollers 18, 19 and the temperature of the second hot pressing rollers 22, 23 can be regulated by the heaters, 18c, 19c, 22c. Further, the pressure of the first hot pressing rollers 18, 19 and the pressure of the second hot pressing rollers 22, 23 can be regulated by the lifting/lowering parts 19e, 23e. As a result, for example, the temperature and the pressure for the shape of surface concaves and convexes of the recording medium P and the thickness of the transferable layer S2 and the heat resistant substrate S1 constituting the transferable sheet S can be supplied as the temperature and pressure of the first hot pressing rollers 18, 19 and the temperature and pressure of the second hot pressing rollers 22, 23.

In this embodiment, the transfer by heating conforming to the shape of surface concaves and convexes on the recording medium P can be realized by the adoption of such a simple construction that second hot pressing rollers 22, 23 are provided.

### SECOND EMBODIMENT

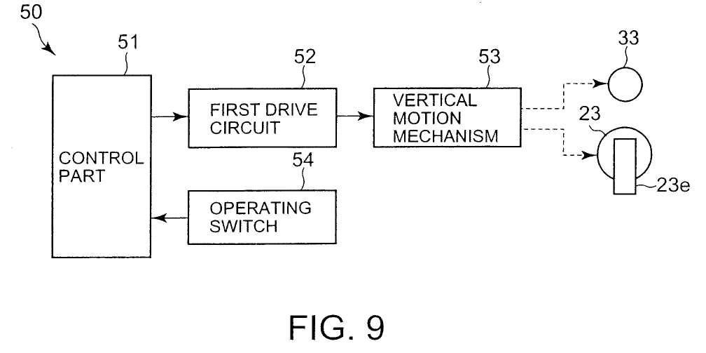

The apparatus in the second embodiment will be described with reference to FIGS. 8 and 9. The construction of this second embodiment is the same as the construction of the first embodiment, except that avoiding means for avoiding the second hot pressing means is additionally provided in the transfer-by-heating part. Further, in FIG. 8, no ink jet recording part is shown. However, also in this embodiment, an ink jet recording part is provided. Accordingly, the avoiding means will be described in detail, and in the drawing, parts common to the first embodiment and the second embodiment are identified with the same reference numerals, and overlapped description will be omitted.

In the apparatus shown in FIG. 8, in a transfer-by-heating part 32, a switching roller 33 as passage switching means constituting the avoiding means is disposed at a position which is on the underside of the guide roller 20 and between the first hot pressing rollers 18, 19 and the second hot pressing rollers 22, 23. The switching roller 33 is vertically movable along a direction indicated by an arrow shown in FIG. 8. The switching roller 33 is disposed at a position where, when the recording medium P with the transferable layer S2 transferred thereon is carried to the second hot pressing rollers 22, 23, the switching roller 33 is spaced from the upper part of the recording medium P. As shown in FIG. 8, when the recording medium P with the transferable layer S2 transferred thereon is avoided from the second hot pressing rollers 22, 23, the switching roller 33 is moved downward and is disposed at a position where the switching roller 33 is rotated while abutting against the upper surface of the recording medium P.

When the switching roller 33 is located at the upper position, the second hot pressing rollers 22, 23 provided on the downstream side of the switching roller 33 can press the recording medium P with the transferable layer S2 transferred thereon in the same manner as in the embodiment shown in FIG. 1. On the other hand, when the switching roller 33 is moved downward, as shown in FIG. 8, the second hot pressing roller 23 is moved downward by the lifting/lowering part 23e to space the second hot pressing roller 23 from the recording medium P with the transferable layer S2 transferred thereon.

Guide rollers 34a, 34b constituting avoiding means are provided on the downstream side of the second hot pressing rollers 22, 23. The guide rollers 34a, 34b are rotated in a direction indicated by an arrow shown in FIG. 8. When the recording medium P with the transferable layer S2 transferred thereon is carried while abutting against the switching roller 33, the guide rollers 34a, 34b support both the upper and lower sides of the recording medium P and guide and carry the recording medium P to an introduction opening of the cutter 24. Therefore, as shown in FIG. 8, the switching roller 33 and the guide rollers 34a, 34b which have been moved downward constitute an avoiding path for avoiding of the second hot pressing means.

Next, a control unit 50 is described with reference to FIG. 9. FIG. 9 is a block diagram showing an electric construction of the control unit 50. In this embodiment, the control unit 50 will be described as an apparatus for driving the avoiding means. The control unit 50 may be one which drives the ink jet recording part 11 and the transfer-by-heating part 32 simultaneously.

The control unit 50 comprises a control part 51 which drives and controls a vertical motion mechanism 53 through a first drive circuit 52. The vertical motion mechanism 53 is constructed to vertically move the switching roller 33 and the lifting/lowering part 23e in the second hot pressing roller 23. Further, the control part 51 receives various instructions sent by the operation of an operating switch 54 and, based on received signals, drives and controls a first drive circuit 52.

The operating switch 54 is constructed so that a first mode and a second mode can be selected. The first mode is a mode that performs both the first hot pressing step and the second hot pressing step which heat the transferable sheet S and the recording medium P and press the transferable sheet S against the recording medium P. The second mode performs only the first hot pressing step but does not perform the second hot pressing step. As soon as the operating switch 54 has selected each mode, a mode setting instruction is sent from the operating switch 54 to the control part 51. Based on this instruction, the control part 51 drives and controls the first drive circuit 52 to drive the vertical motion mechanism 53.

In a preferred embodiment of the present invention, when the surface roughness of the printing surface (receptive layer) of the recording medium P as measured according to JIS B 0601 is not less than 0.15, the first mode is selected. The recording medium P having a printing surface of which the surface roughness is not less than 0.15, the printing surface is slightly rough and, for example, has a special texture such as a semi-glossy or luster texture. This recording medium P is particularly suitable for the preparation of silver salt photograph-like prints. The term “semi-glossy” as used herein refers to the so-called “silk-like tone” that is a texture of gloss which is between glossy tone and matte tone. The term “luster” as used herein refers to a texture of gloss which is between glossy tone and matte tone and is somewhat rougher than the semi-glossy tone. Thus, when the first hot pressing step is carried out using a recording medium P having a slightly rough surface, since the printing surface is slightly rough, even in the absence of a deposit, air bubbles (nonbonded space) are likely to be included between the printing surface and the transferable sheet S. A print free from the inclusion of air bubbles can be prepared by performing the second hot pressing step after the transfer of the transferable layer onto the recording medium P to allow air bubbles included between the recording medium P and the transferable layer to disappear. Preferably, the first mode is selected when the surface roughness of the printing surface (receptive layer) is 0.15 to 5.0, more preferably 0.15 to 4.5. This can improve the texture or gloss of the print and, at the same time, can prevent inclusion of air bubbles.

On the other hand, when a recording medium P having a printing surface of which the surface roughness is less than 0.15 as measured according to JIS B 0601 is used, the second mode is selected by the operating switch 54. In this recording medium P, since the printing surface is smooth, air bubbles are hardly included between the transferable sheet S and the printing surface. Therefore, in this case, subjecting the assembly of the recording medium P and the transferable sheet S free from the inclusion of air bubbles to the second hot pressing step is unnecessary and, if done, is likely to deteriorate the gloss and texture of the transferred layer. For this reason, when the printing surface is smooth, the second mode is selected to omit the second hot pressing step from the viewpoint of maintaining the gloss and texture.

The surface roughness refers to surface roughness SRa with a cutoff value of 0.8 mm as measured with a tracer type three-dimensional surface roughness meter and is determined by equation 1:

$$SRa = \frac{1}{Sa} {\int }_{0}^{Wx} {\int }_{0}^{Wx} \vert f ( X , Y ) \vert d X , d Y$$

The method for avoiding the second hot pressing means in the second mode will be described. At the outset, the control part 51 drives and controls the first drive circuit 52 to move the second hot pressing roller 23 downward and, further, to move the switching roller 33 downward. As a result, the second hot pressing rollers 22, 23 are spaced from the recording medium P with the transferable layer S2 transferred thereon, the pressure is released, and the recording medium P is carried while the upper side of the recording medium P is pressed by the switching roller 33. That is, as shown in FIG. 8, the recording medium P with the transferable layer (transferable layer S2 and adhesive layer S3) transferred thereon avoids the second hot pressing rollers 22, 23 and is carried to the cutter 24 through the avoiding path. The recording medium P is cut into a predetermined length by the cutter 24 to form ink jet records M as a print which has avoided the step of heating by the second heat pressing rollers 22, 23. Thus, ink jet records M free from the inclusion of air bubbles and having improved gloss and texture can be prepared.

When the transfer by heating through the second hot pressing rollers 22, 23 is carried out again, the same transfer by heating as in the first embodiment can be carried out by moving the second hot pressing roller 23 upward and moving the switching roller 33 upward.

The apparatus in this embodiment has the following advantages.

In this embodiment, the transfer by heating can be carried out without the provision of the second hot pressing rollers 22, 23 by the adoption of a simple construction in which the switching roller 33 and the second hot pressing roller 23 are vertically moved. As a result, the transfer by heating using the second hot pressing rollers 22, 23 and the transfer by heating not using the second hot pressing rollers 22, 23 (avoiding the second hot pressing rollers 22, 23) can easily be switched.

### THIRD EMBODIMENT

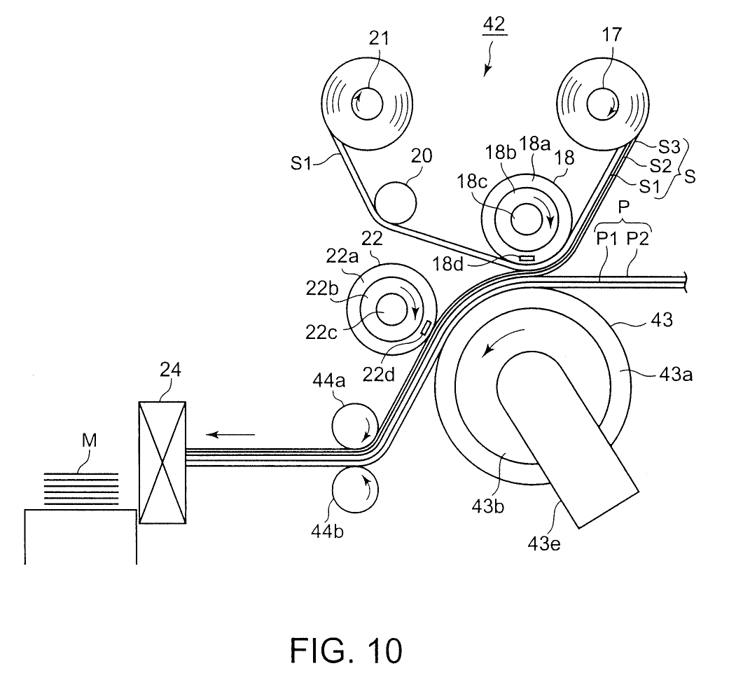

Next, the third embodiment will be described with reference to FIG. 10. The construction of this third embodiment is the same as the construction of the first embodiment, except that the first and second hot pressing rollers in the transfer-by-heating part have been changed. In FIG. 10, no ink jet recording part is shown. In this embodiment as well, however, an ink jet recording part is provided. Therefore, the first and second hot pressing rollers will be described in detail, and, in the drawing, parts common to the first embodiment and the third embodiment are identified with the same reference numerals, and overlapped description will be omitted.

In the apparatus shown in FIG. 10, in the transfer-by-heating part 42, the first hot pressing roller 18 and the second hot pressing roller 22 are disposed so as to face the first hot pressing roller 43 constituting the first hot pressing means.

The first hot pressing roller 43 is a cylindrical roller having an outer shape larger than the outer shape of the first hot pressing roller 18 and the second hot pressing roller 22 and is provided with an elastic part 43a and a metallic roller 43b.

The elastic part 43a is formed of an elastic body, for example, a synthetic resin such as silicone rubber disposed on the outermost circumference of the first hot pressing roller 43. The elastic part 43a covers the whole circumference of the metallic roller 43b underlying the elastic part 43a. The metallic roller 43b is a cylindrical roller formed of a metal such as iron steel and is rotated in a direction indicated by an arrow in FIG. 10. The elastic part 43a can be rotated in conjunction with the rotation of the metallic roller 43b. In the lifting/lowering part 43e, the position of the first hot pressing roller 43 is regulated to set each of the pressure between the first hot pressing rollers 18, 43 and the pressure between the second hot pressing roller 22 and the first hot pressing roller 43. The pressure of the first and second hot pressing rollers 18, 22 is measured with a pressure gage (not shown) provided in the lifting/lowering part 43e.

Accordingly, as shown in FIG. 10, the first hot pressing roller 43 can perform the first hot pressing step in cooperation with the first hot pressing roller 18. The first hot pressing roller 43 can perform the second hot pressing step in cooperation with the second hot pressing roller 22.

The guide rollers 44a, 44b are disposed on the downstream side of the second hot pressing roller 22. The guide rollers 44a, 44b are provided so as to face an introduction port (not shown) of the cutter 24. The guide rollers 44a, 44b support the upper and lower sides of the recording medium P with the transferable layer S2 transferred thereon and guide and carry the recording medium P to an introduction opening of the cutter 24.

This apparatus is operated as follows. Specifically, the recording medium P and the transferable sheet S are carried in between the first hot pressing rollers 18, 43 to perform the first hot pressing step. The recording medium P with the transferable layer S2 transferred thereon is carried along the outer circumference of the first hot pressing roller 43 through the separating step and is carried in between the second hot pressing roller 22 and the first hot pressing roller 43. The recording medium P with the transferable layer S2 transferred thereon is again hot pressed by the second hot pressing roller 22 and the first hot pressing roller 43. As a result, the recording medium P with the adhesive layer S3 and the transferable layer S2 conforming to the shape of surface concaves and convexes of the recording medium P is formed to complete the second hot pressing step. The recording medium P is carried through the guide rollers 44a, 44b to a cutter 24 to complete the transfer by heating and to form ink jet records M as a print.

The apparatus in this embodiment has the following advantageous effects.

In this embodiment, the first hot pressing means and the second hot pressing means are constituted by the first hot pressing rollers 18, 43 and the second hot pressing rollers 22, that is, three pairs of rollers. As a result, the construction of the transfer-by-heating part can be simplified.

Further, in this embodiment, the first hot pressing roller 18 and the second hot pressing roller 22 are disposed on the first hot pressing roller 43. As a result, the carrying path from the first hot pressing roller 18 to the second hot pressing roller 22 can be shortened. Therefore, the productivity of the transfer by heating confirming to the shape of surface concaves and convexes of the recording medium P can be improved.

This embodiment can be changed as follows.

In this embodiment, the separating means is provided between the first hot pressing rollers (18, 19) as the first hot pressing means and the second hot pressing roller (22, 23) as the second hot pressing means. Alternatively, the separating means may be provided on the downstream side of the second hot pressing means (22, 23).

In this embodiment, the elastic parts 18a, 19a, 43a are provided on the outermost circumference of the first hot pressing rollers 18, 19, 43 constituting the first hot pressing means. Alternatively, the outermost surface of the metallic rollers 18b, 19b, 43b may be the outermost circumference of the first hot pressing rollers 18, 19, 43. Further, in this embodiment, the elastic parts 22a, 23a are provided on the outermost circumference of the second hot pressing rollers 22, 23 constituting the second hot pressing means. Alternatively, the outermost circumference of the metallic rollers 22b, 23b may be the outermost circumference of the second hot pressing rollers 22, 23. Further, the outermost circumference of the first hot pressing rollers 18, 19, 43 and the outermost circumference of the second hot pressing rollers 22, 23 may be constituted by a metallic roller.

In this embodiment, the first hot pressing roller 43 is a nonheating-type roller not provided with a heater. Alternatively, a heating-type roller may be used.

In this embodiment, the transferable sheet S has a three-layer structure of the heat resistant substrate S1, the transferable layer S2 and the adhesive layer S3. Alternatively, the transferable sheet S may have a two-layer structure of the heat resistant substrate S1 and the heat-bondable transferable layer S2. In this case, the transferable layer S2 functions also as an adhesive layer.

### Examples

The following Examples and Test Examples demonstrating the effect of the present invention further illustrate the present invention but are not intended to limit it.

### Preparation of Transferable Sheets

A PET film (Lumirror S10, manufactured by Toray Industries, Inc., thickness 23 μm) was provided as a heat resistant substrate for the preparation of transferable sheets for glossy prints. On the other hand, a PET film (Lumirror X42, manufactured by Toray Industries, Inc., thickness 23 μm) was provided as a heat resistant substrate for the preparation of transferable sheets for low-gloss, that is, the so-called “matte” prints. Coating liquid A having the following composition and coating liquid B having the following composition were coated in that order on one side (a front face) of each of these films, followed by drying. Thus, a 5 μm-thick adhesive layer S3 formed from coating liquid B was stacked on a 4 μm-thick protective layer as a transferable layer formed from coating liquid A. Each film with the transferable layer stacked thereon was wound around a paper core to form roll-like transferable sheets S (two sheets, a sheet for a glossy print and a sheet for a matte print).

### Composition of Coating Liquid A

Movinyl 8020 (colloidal silica-containing emulsion, a product of Clariant Polymers K.K., glass transition temperature −22° C.); 47.6% by weight
Movinyl 790 (acrylic emulsion, a product of Clariant Polymers K.K., glass transition temperature 102° C.); 31.7% by weight
Snowtex 30 (colloidal silica, a product of Nissan Chemical Industry Ltd.); 15.9% by weight
SANLEAF CLA-3 (wax emulsion, a product of Sanyo Chemical Industries. Ltd.); 3.8% by weight
Texanol (film-forming assistant, a product of Chisso Corp.); 1.0% by weight

### Composition of Coating Liquid B

Movinyl 727 (acrylic emulsion, a product of Clariant Polymers K.K., glass transition temperature 16° C.); 99.0% by weight
Texanol (film-forming assistant, a product of Chisso Corp.); 1.0% by weight

### Preparation of Prints

An ink jet printer for a pigment ink (PM-4000PX, manufactured by Seiko Epson Corporation) was provided. This printer was used to print a high-resolution color digital standard image (ISO/JIS-SCID, image name “Portrait”, sample No. 1, image evaluation identification No. N1) in a “recommended beautiful mode.” Further, three prints different from each other in texture, i.e., print 1, print 2, and print 3 were prepared.

### Print 1 (Glossy Print):

“Photo Paper (glossy)” manufactured by Seiko Epson Corporation was provided as recording medium P. The printing surface of the recording medium P had a surface roughness SRa specified in JIS B 0601 of 0.11.

### Print 2 (Semi-Glossy Print):

“Photo Paper (semi-glossy)” manufactured by Seiko Epson Corporation was provided as recording medium P. The printing surface of the recording medium P had a surface roughness SRa of 0.71.

### Print 3 (Luster Print):

“CRYSTARIO specialty paper (premium luster photo paper)” manufactured by Seiko Epson Corporation was provided as recording medium P. The printing surface of the recording medium P had a surface roughness SRa of 0.17.

The surface roughness of recording medium P was measured with a fine shape measuring device (SURFCORDER ET 4000, manufactured by Kosaka Laboratory Ltd.) under conditions of cutoff value 0.8 mm, X pitch=0.3 μm, Y pitch=2 μm, and speed 0.05 mm/sec.

### Preparation of Ink Jet Records

A transfer-by-heating part 32 was used to transfer each transferable sheet S prepared above by heating onto print 1, print 2, and print 3 to form four prints.

### Examples 1 and 2

For glossy print 1, the transferable sheet for a glossy print prepared above was used to prepare a glossy ink jet record as a sample of Example 1. Further, for print 1, the transferable sheet for a matte print was used to prepare a matte ink jet record as a sample of Example 2. In the preparation of the ink jet records, the second hot pressing step was omitted, and only the first hot pressing step was carried out. Hot pressing in the transfer-by-heating part 32 was carried out under conditions of carrying speed of print 1 15 mm/sec, heat temperature of upper and lower first hot pressing rollers 18, 19 (see FIG. 1) respectively 100° C. and 70° C., and nip pressure 10 kg/cm². Further, the heating temperature of the upper second hot pressing roller 22 was 90° C., and the nip pressure of the second hot pressing rollers 22, 23 was 5 kg/cm².

### Example 3

For semi-glossy print 2, the transferable sheet S for a glossy print was used to prepare a semi-glossy ink jet record as a sample of Example 3. In this case, print 2 was subjected to the first and second hot pressing steps. Hot pressing conditions in the transfer-by-heating part 32 were the same as those in Examples 1 and 2.

### Example 4

For luster print 3, the transferable sheet S for a glossy print was used to prepare a luster ink jet record as a sample of Example 4. In this case, print 3 was subjected to the first and second hot pressing steps. Hot pressing conditions in the transfer-by-heating part 32 were the same as those in Examples 1 and 2.

### Comparative Examples 1 and 2

For print 1, the first and second hot pressing steps were carried out using the transferable sheet for a glossy print and the transferable sheet for a matte print to prepare ink jet records respectively as a sample of Comparative Example 1 and a sample of Comparative Example 2. That is, Comparative Examples 1 and 2 are different from Examples 1 and 2 in that the first hot pressing step was followed by the second hot pressing step.

### Comparative Examples 3 and 4

For prints 2 and 3, only the first hot pressing step was carried out using the transferable sheet for a glossy print to prepare ink jet records respectively as a sample of Comparative Example 3 and Comparative Example 4. That is, Comparative Examples 3 and 4 are different from Examples 3 and 4 in that the second hot pressing step was omitted.

### Evaluation Tests

The samples of Examples 1 to 4 and Comparative Examples 1 to 4 were evaluated for inclusion of air bubbles and texture.

Each sample (ink jet record) was visually inspected for inclusion of air bubbles in the surface (print surface). When the inclusion of air bubbles was not observed at all, the sample was evaluated as A; and when the inclusion of air bubbles was observed, the sample was evaluated as B.

When the transferable sheet for a glossy print was used for print 1 to provide a glossy texture, a sample with a gloss of not less than 60 degrees was evaluated as A; and a sample with a gloss of less than 60 degrees was evaluated as B. This gloss was measured by a 20-degree specular gloss measuring method (PG-1M, manufactured by Nippon Denshoku Co., Ltd.) specified in JIS Z 8741.

When the transferable sheet for a matte print was used for print 1 to provide a matte texture, a sample with a gloss of not more than 10 degrees was evaluated as A; and a sample with a gloss of more than 10 degrees was evaluated as B.

When the transferable sheet for a glossy print was used for print 2 to provide a semi-glossy texture, a sample with a gloss of 10 to 30 degrees was evaluated as A; and a sample with a gloss of more than 30 degrees was evaluated as B.

When the transferable sheet for a glossy print was used for print 3 to provide a luster texture, a sample with a gloss of 10 to 30 degrees was evaluated as A; and a sample with a gloss of more than 30 degrees was evaluated as B.

The results were as shown in Table 1.

TABLE 1

| | | | | | | Texture | | |
|---|---|---|---|---|---|---|---|---|
| | | | Transferable | Second hot | Inclusion of air | | Semi- | |
| | Overcoated object | | sheet | pressing step | bubbles | Glossy | glossy | Matte |
| Example 1 | Print 1 | Glossy | For glossy print | Not done | A | A | — | — |
| Example 2 | Print 1 | Glossy | For matte print | Not done | A | — | — | A |
| Example 3 | Print 2 | Semi-glossy | For glossy print | Done | A | — | A | — |
| Example 4 | Print 3 | Luster | For glossy print | Done | A | — | A | — |
| Comparative | Print 1 | Glossy | For glossy print | Done | A | B | — | — |
| Example 1 | | | | | | | | |
| Comparative | Print 1 | Glossy | For matte print | Done | A | — | — | B |
| Example 2 | | | | | | | | |
| Comparative | Print 2 | Semi-glossy | For glossy print | Not done | B | — | B | — |
| Example 3 | | | | | | | | |
| Comparative | Print 3 | Luster | For glossy print | Not done | B | — | B | — |
| Example 4 | | | | | | | | |

1. An apparatus for overcoating a protective layer by heating onto a recording medium, the apparatus comprising:
means for feeding a transferable sheet comprising at least a heat resistant substrate and a transferable layer;
means for feeding a recording medium;
first hot pressing means for putting the transferable sheet on the recording medium and, in this state, heating and pressing the transferable sheet and/or the recording medium to contact-bond the transferable layer onto the recording medium; and
second hot pressing means for heating and pressing the transferred layer contact-bonded to the recording medium.

2. The apparatus according to claim 1, which further comprises separation means for separating the heat resistant substrate from the transferred sheet contact-bonded to the recording medium.

3. The apparatus according to claim 1, wherein the temperature and pressure in the second hot pressing means are lower than the temperature and pressure in the first hot pressing step.

4. The apparatus according to claim 1, wherein the first hot pressing means and/or the second hot pressing means comprise regulation means for regulating the temperature and pressure of the first hot pressing means and/or the second hot pressing means.

5. The apparatus according to claim 1, which comprises avoidance means for avoiding the transferred layer in the transferable sheet contact-bonded to the recording medium from the second hot pressing means.

6. The apparatus according to claim 5, wherein the avoidance means avoids the transferred layer in the transferable sheet from the second hot pressing means when the surface roughness of a surface of the recording medium onto which the transferable layer is contact-bonded is less than 0.15 as measured according to JIS B 0601.

7. The apparatus according to claim 1, which comprises ink jet recording means for ejecting ink droplets onto the recording medium to form an image before putting the transferable sheet thereon.
